(19) United States
(12) Patent Application Publication
(10) Pub. No.: US 2010/0019727 A1
(43) Pub. Date: Jan. 28, 2010

(54) BATTERY IDENTIFICATION CYCLE

(76) Inventors: Eckhard Karden, Aachen (DE); Stephen Robert Pickering, Coventry (GB); Erik Surewaard, Terheijden (NL); Engbert Spijker, Nuth (NL); Ralf Hecke, Aachen (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 12/508,807

(22) Filed: Jul. 24, 2009

(30) Foreign Application Priority Data
Jul. 24, 2008 (DE) 102008034461.3

(51) Int. Cl. H02J 7/00

(52) U.S. Cl. 320/129; 320/134

(57) ABSTRACT

The present invention relates to a method and a device for detecting the operating state of a vehicle battery. A method according to the invention has the following steps: charging of the battery from a first state of charge (SOC1) to a second state of charge (SOC2), wherein the second state of charge (SOC2) is higher than the first state of charge (SOC1); active discharging of the battery to a third state of charge (SOC3), wherein the third state of charge (SOC3) is lower than the second state of charge (SOC2); and determination of at least one variable, which is characteristic of the operating state of the battery, after the third state of charge (SOC3) has been reached.

The present invention relates to a method and a device for detecting the operating state of a vehicle battery.

Vehicle batteries are frequently operated with a state of charge (SOC) below the maximum possible state of charge. This can be done unintentionally (for example as a result of an existing incorrect ratio between the charging requirement and the possible charging, for example in the high load operating mode or after a relatively long stationary time of the vehicle) or else intentionally, if, for example, the possibility of the vehicle battery absorbing charge is to be increased in a micro-hybrid drive train.

Basically, it is very important to detect the state of charge (SOC) and battery capacity as precisely as possible since they constitute input signals for the control strategy. However, in numerous battery technologies, for example lead/acid batteries, the problem occurs that both the state of charge and the battery capacity are not accessible to direct measurement. On the other hand, it is known that both the battery capacity (due to manufacturing tolerances, aging processes and replacement of the battery) and algorithms for detecting the state of charge (which include, for example, the detection of the characteristic equilibrium voltage of the battery as a function of the state of charge) are subject to severe fluctuations.

EP 1 324 062 B1 discloses a method for detecting the operating state of a vehicle battery in which a temperature variable which correlates with the battery temperature is measured, and the state of charge and a further state variable (for example the internal resistance of the vehicle battery) are detected. Then, a reference value is formed from the relationship between the detected state variable and a corresponding state variable of a new vehicle battery of the same type, the current state of ageing of the vehicle battery is determined from the reference value and the known comparison reference values for the measured temperature variable and the detected state of charge, and a predicted state variable which corresponds to the detected state variable is determined as a measure of the operating state.

U.S. Pat. No. 6,583,599 B1 discloses a method and a device for controlling the battery charge in a hybrid electric vehicle, wherein the control device has eight battery state of charge threshold values which determine the hybrid operating mode of the hybrid electric vehicle, and wherein the value of the state of charge of the battery with respect to the threshold values is a factor for determining the hybrid mode, for example regenerative braking, charging, discharging the battery or boosting of the torque.

EP 0 718 950 A2 discloses a generator control device of a hybrid electric vehicle in which, in particular, a setpoint value control of the state of charge (SOC) of the battery is performed within a setpoint range by actively discharging or charging the battery.

EP 0 645 278 B1 discloses a generator controller for controlling operation of a generator in a hybrid vehicle, in which the state of charge of the battery is controlled within a predetermined setpoint range, wherein the output power of the generator is used to charge the battery for a specific time period if a high load state of the battery is sensed.

An object of the present invention is to make available a method and a device for detecting the operating state of a vehicle battery by means of which the operating state can be determined with the highest possible degree of precision and consistency.

This object is achieved by means of a method having the features according to independent claim 1 and a device having the features according to independent claim 10. Further refinements of the invention can be found in the description and the subclaims.

A method for detecting the operating state of a vehicle battery has the following steps:
charging of the battery from a first state of charge to a second state of charge, wherein the second state of charge is higher than the first state of charge;
active discharging of the battery to a third state of charge wherein the third state of charge is lower than the second state of charge; and
determination of at least one variable, which is characteristic of the operating state of the battery, after the third state of charge has been reached.

The vehicle battery is typically included in a power supply system of the vehicle, which power supply system has a battery monitoring system (BMS) with a plurality of sensors (for example sensors for the battery voltage and/or the battery current and/or the battery temperature), wherein this battery monitoring system (BMS) is configured to implement an algorithm which calculates state parameters which are characteristic of the operating state, for example the state of charge (SOC) and the battery capacity. Since, according to the invention, the variable which is characteristic of the operating state of the battery is determined after active discharging of the battery, the battery monitoring system (BMS) is provided with the opportunity of improving the internal capacity model on the basis of the discharge behavior, as a result of which the precision and consistency when detecting the operating state can be increased.

According to one preferred embodiment, after the third state of charge has been reached, a current pulse is applied, during which the discharge current equals at least twice, preferably at least three times, and even more preferably at least four times, the charge current during the transition from the first state of charge into the second state of charge, which permits the algorithm for detecting the operating state of the battery to be supported.

In a further advantageous embodiment, after the third state of charge has been reached, a current pulse is applied during which the charge current equals at least the two-hour discharge current, in particular the one-hour discharge current of the battery. In this context, the two-hour charge current is defined as the computational discharge current which occurs when the battery capacity is divided by a time period of two hours. Given a battery capacity of, for example, 80 ah, the two-hour discharge current would accordingly be 40 A. The one-hour discharge current is calculated in an analogous fashion, and in this case it then equals 80 A. These relatively high discharge currents ensure that the algorithm for detecting the operating state of the battery is supported.

According to one preferred embodiment, initiation and/or termination of the charging from the first state of charge to the second state of charge takes place as a function of the temperature. This makes it possible to ensure that refreshing of the state of charge which takes place according to the invention occurs, for example, only if the battery temperature is above a specific threshold value.

According to one preferred embodiment, after the battery has been charged to the second state of charge and/or after it has been charged the third state of charge, said battery is kept at the respective state of charge for a predetermined time period. In this way, the battery monitoring system (BMS) can be provided with the opportunity of re-calibrating its internal SOC model until, for example, it is possible to determine the open-circuit voltage of the battery in a reliable manner.

The invention will be explained in more detail below using preferred embodiments and with reference to the appended figures, of which:

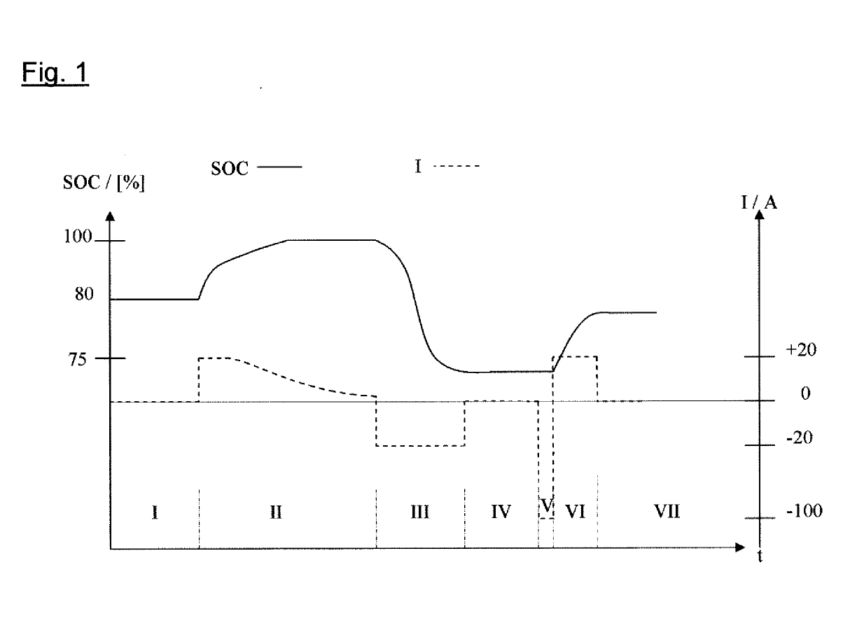

FIG. 1 shows a diagram in which both the state of charge (SOC) and the battery charge current are represented as a function of time during different phases of the method according to the invention;

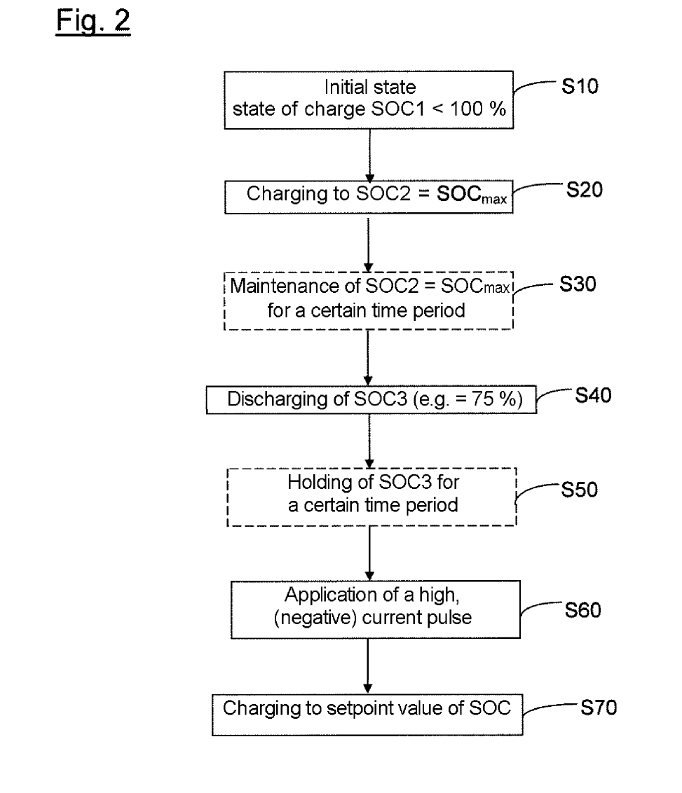

FIG. 2 shows a flowchart explaining the sequence of the method according to the invention according to a preferred embodiment;

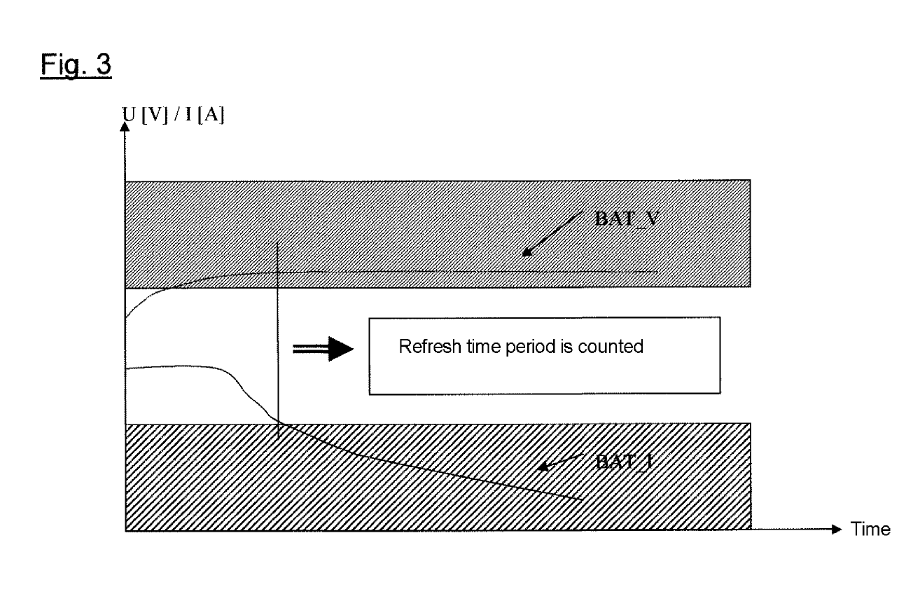

FIG. 3 shows the profile of the battery voltage and of the charge current as a function of the time in order to explain a preferred embodiment of the invention; and

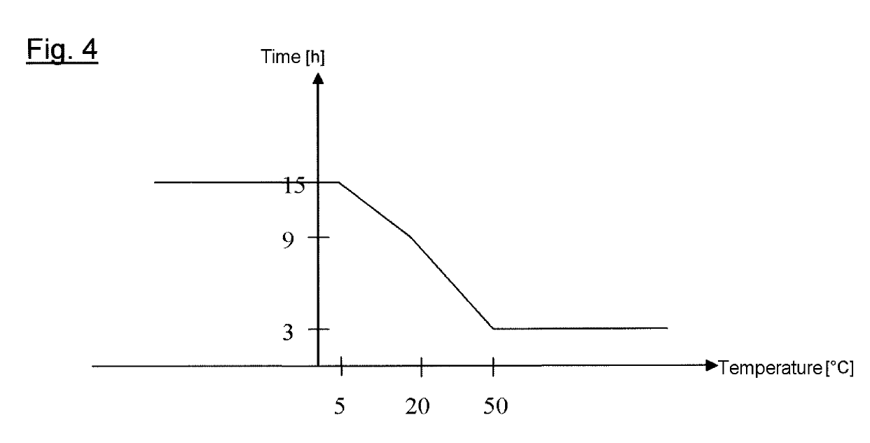

FIG. 4 shows a diagram illustrating the temperature-dependent weighting of individual time periods during a refreshing cycle which is performed during the method according to the invention.

The method according to the invention is applied to a vehicle battery which is included in the power supply system of the vehicle, this power supply system having the following components:
a battery monitoring system (BMS) which has a plurality of sensors (e.g. sensors for the battery voltage and/or the battery current and/or the battery temperature) and which is configured to implement an algorithm which calculates state parameters which are characteristic of the operating state, these being for example the state of charge (SOC) and the battery capacity;
a regulated generator, for example a dynamo or a starter generator whose voltage setpoint value can be regulated by means of an electronic control unit (ECU);
and (optionally) a power distribution management (PDM) system by means of which the power supply of individual loads can be controlled (for example deactivation of the stop/start function of a hybrid vehicle or micro-hybrid vehicle.

The invention makes available a method for improving the precision and consistency of the state parameters, such as for example the state of charge (SOC) and the battery capacity, which are supplied by the battery monitoring system (BMS) and are characteristic of the operating state.

The individual phases of the method according to the invention will be explained in detail below with reference to FIG. 1, which shows the time dependence both of the state of charge (SOC, left-hand vertical axis and continuous curve in the diagram) and of the charge current of the battery (right-hand vertical axis and dashed curve in the diagram), as well as to the flowchart illustrated in FIG. 2.

In the phase which is denoted by “I” in FIG. 1, the battery is in the initial state in which the state of charge (SOC value) corresponds to an SOC setpoint value below 100% and in which the battery charge current is regulated to zero (see also step S10 in FIG. 2).

In the subsequent step (phase “II” according to FIG. 1 and step S20 according to FIG. 2), the power supply system charges the battery with a high priority and by applying the highest possible charge voltage, with both the lifetime of the battery and the voltage quality requirements of the loads being taken into account. The battery current is positive (according to the right-hand scale and the dashed curve in FIG. 1). The phase “II” according to FIG. 1 is therefore defined by a refreshing cycle in which the battery is completely charged with the positive battery charge current (+20 ampere in the example).

A correspondingly high charge voltage is applied for several hours, which can also occur with an interruption, depending on the operating state of the vehicle, for example ignition deactivation. This ensures that the battery reaches the maximum possible state of charge (SOC) under the respective given conditions. This maximum state of charge (SOC) may be less than 100% of the standard capacity since the charge voltage and the charge time are limited in the vehicle. The charge voltage and duration of the charge period which occurs with the high priority are preferably regulated by the battery monitoring system (BMS). This can be achieved by means of a voltage setpoint value and a “refresh charge request” flag.

Measures for optimizing charging the battery can optionally be taken by means of the power distribution management (PDM) system. In particular, for example the load power can be reduced during the high-voltage charging period if the generator is being fully utilized. Furthermore, functions which can contribute to discharging of the battery, for example the stop/start function and similar vehicle functions, can be deactivated.

As is apparent from FIG. 1, in phase “II” the battery can be kept at the maximum state of charge (SOC) until the open-circuit voltage of the battery can be reliably determined. The corresponding optional step is denoted by S30 in FIG. 2. This typically requires deactivation of the ignition (parking of the vehicle) for a specific minimum period. In this way, the battery monitoring system (BMS) is provided with the opportunity of re-calibrating the internal SOC model, for example of setting an equilibrium by means of the SOC curve as soon as the state of charge (SOC) has been detected with the best possible precision. This can be implemented in practice by setting the “refresh charge request” flag to “high” until the re-calibration of the internal SOC model is terminated.

The phase “III” according to FIG. 1 is defined by an identification cycle in which the battery is discharged to a low SOC level (approximately 75% in the example) by setting a negative battery charge current of, in the example, −20 ampere (step S40 in FIG. 2).

In this phase “III” the battery is discharged into the electrical loads in the vehicle at a significant rate according to the regulation process by means of the energy management system. The battery current is negative (according to the right-hand scale and the dashed curve in FIG. 1). This discharging occurs to the lowest possible SOC value which still ensures reliable operation of the vehicle under the given conditions (for example SOC=75%). This is intended to provide the battery monitoring system (BMS) with the opportunity of improving the internal capacity model, which can be based on the discharge behavior during the discharging which occurs at a medium or high rate. The discharge can be implemented in practice by setting a “refresh discharge request” flag to “high” until the lowest possible SOC value is reached. The power supply management (PSM) system then regulates the generator voltage to a low value which actuates the battery to discharge, and this replaces the normal charging strategy. The power distribution management (PDM) system can optionally actuate the loads in such a way that the discharge current is maximized or stabilized.

As is apparent from FIG. 1, the battery can be kept at the lowest possible SOC value until it has become possible to determine the open-circuit voltage of the battery reliably. The corresponding optional step is denoted in FIG. 2 by S50. This typically requires deactivation of the ignition (parking process) for a certain minimum period. As a result, the battery monitoring system can be provided with the opportunity of re-calibrating the internal SOC model, for example of resetting the equilibrium value according to the SOC curve (see step 1a). This can be implemented in practice by setting the “refresh discharge” flag to “high” until the re-calibration of the internal SOC model is terminated. In this case, further discharging of the battery by means of the PSM and PDM strategies should be avoided, and in this context the SOC value is obtained by means of the battery monitoring system (BMS).

During the phase “IV” in which the battery is at the relatively low SOC level, a high current pulse is required in order to support the algorithm for determining the operating state of the battery. In the exemplary embodiment shown, according to FIG. 1, the current is initially regulated to zero in the phase IV before a high, negative current pulse of −100 ampere (A) is applied in the phase “V” (cf. step S50 in FIG. 2). However, the phase “IV” before the high, negative current pulse is applied in phase “V” is optional.

To conclude, a reversal occurs with respect to the normal settings, for example with respect to a (for example) relatively high setpoint value of the state of charge (SOC). During the phase “VI”, according to FIG. 1 the battery is charged again to its SOC setpoint value, for which purpose a positive charge current of, in the example, +20 ampere is set (see step S70 in FIG. 2). The phase “VII” according to FIG. 1 corresponds in turn to a set, new initial state with a set SOC setpoint value below 100%. The steps described above are initiated by one or more of the following events (“trigger” events):
a1) certain time intervals or calendar intervals expire (operating period of the battery in time units);
a2) certain kilometer readings (operating period of the battery in kilometers) are reached;
a3) certain battery charging intervals or energy throughput intervals (operating period of the battery in ampere hours (ah) or watt hours (wh) expire;
a4) certain events, for example deep discharge of the battery to below a predetermined SOC threshold value;
a5) disconnection of the battery, for example proof of an interruption in the BMS (battery monitoring system) power supply, for example when the battery is replaced; or
a6) lack of correspondence between the indicated values for the state of charge (SOC) and/or the battery capacity at the battery monitoring system and in terms of other observed variables.

Furthermore, after one or more trigger events have occurred, the steps provided according to the invention can also be postponed or delayed if one or more of the following postponement conditions are met:
b1) excessively low battery temperature (poor take up of charge); in this case it is possible, for example, to wait until a specific temperature threshold value is exceeded for a minimum time period;
b2) current operating state of the vehicle does not permit a high priority for charging (for example when the stop/start function is currently deactivated, complete throttling is occurring etc.);
b3) more suitable conditions are waited for owing to requests from other vehicle systems, for example during the cleaning of the diesel particle filter; or
b4) more suitable conditions are waited for owing to a prediction algorithm, for example a freeway journey programmed into the navigation system.

According to one preferred refinement of the invention, a refresh cycle (during which the battery is completely charged and which is initiated periodically in order to increase the lifetime of, for example, a lead/acid battery) takes place as a function of temperature. In particular, both the initiation of such a refresh cycle and the duration of the refresh cycle are dependent on temperature.

As far as the initiation of the refresh cycle is concerned, it is preferably carried out only if one of the following three conditions is met:

T_{bat}>T₁; or i)

T₂<T_{bat}<T₁ und G>G₁>0; or t ii)

Here, T_{bat} denote the battery temperature, G denotes the battery temperature gradient and T1, T2, G1 and t1 denote predetermined threshold values of the battery temperature, of the battery temperature gradient and of the duration of the refresh cycle, respectively.

In other words, in order to initiate the refresh cycle, the value of the battery temperature must either be above a specific, first threshold value or it must be above a specific, second lower threshold value, in which case the temperature gradient must at the same time be above a specific positive threshold value (G₁). If none of these two conditions a) and b) is met, the refresh cycle is not triggered until after a specific time period t₁ has expired or a specific time window has been exited.

Basically, the refresh cycle is also initiated here on the basis of the battery monitoring system (BMS) based on the lifetime of the battery and/or its charge throughput, but if the corresponding integral limits for a predefined time window are reached, both the battery temperature and the temperature gradient are measured so that the actual implementation of the refresh cycle does not take place until one of the conditions a), b) or c) is met.

As far as the termination of the refresh cycle is concerned, it also preferably takes place as a function of the temperature. In this case the refresh time is limited as a function of the temperature. It is to be noted in this context that this refresh time is counted only during phases or periods in which the charge current and battery voltage are within defined limits, as illustrated in FIG. 3. FIG. 3 shows the profile of the battery voltage and of the charge current as a function of the time, with the vertical line illustrating that the refresh time is calculated only from the time at which the battery voltage is above a specific threshold value, and the battery current is below a specific threshold value. Specifically, the battery voltage must be higher than the generator voltage minus a given offset, and the battery current must be lower than a limiting value which corresponds to the rated capacity of the battery, and higher than zero.

In this context, according to FIG. 4 the individual time periods are weighted during the refresh cycle as a function of the temperature. In the example, the charging in the refresh cycle occurs for a duration of 1 hour at a temperature of 5° C., for a duration of 1 hour at a temperature of 20° C. and for a duration of 1 hour at a temperature of 50° C. This results in the following time periods which are weighted with respect to the temperature:

1 h at 5° C.: weighted time period=1 h*15 h/15 h=1 h

1 h at 20° C.: weighted time period=1 h*15 h/9 h=1.67 h

1 h at 50° C.: weighted time period=1 h*15 h/3 h=5 h

The sum of these weighted time periods is therefore 7.67 h. The refresh cycle is terminated as soon as said sum of the weighted time periods is greater than the maximum time period in the t(T) curve (i.e. greater than 15 h in the example).

1. A method comprising:
charging of a battery from a first state of charge to a second state of charge higher than the first state of charge,
active discharging of the battery to a third state of charge lower than the second state of charge; and
determination of at least one variable, which is characteristic of the operating state of the battery, after the third state of charge has been reached.

2. The method as claimed in claim 1, wherein the state of charge and/or the battery capacity are/is determined as a variable or variables which is/are characteristic of the operating state of the battery.

3. The method as claimed in claim 1, wherein the second state of charge corresponds to the maximum state of charge of the vehicle battery under the given conditions.

4. The method as claimed in claim 1, wherein after the third state of charge (SOC3) has been reached, a current pulse is applied during which the discharge current equals at least twice, preferably at least three times, and even more preferably at least four times, the charge current during the transition from the first state of charge (SOC1) into the second state of charge (SOC2).

5. The method as claimed in claim 1, wherein after the third state of charge (SOC3) has been reached, a current pulse is applied, during which the discharge current equals at least the two-hour discharge current, in particular the one-hour discharge current of the battery.

6. The method as claimed in claim 1, wherein initiation and/or termination of the charging from the first state of charge (SOC1) to the second state of charge (SOC2) takes place as a function of temperature.

7. The method as claimed in claim 1, wherein after the battery has been charged to the second state of charge (SOC2), said battery is kept at the second state of charge for a predetermined time period.

8. The method as claimed in claim 1, wherein after the battery has been charged to the third state of charge (SOC3), said battery is kept at the third state of charge for a predetermined time period.

9. The method as claimed in claim 1, wherein the charging of the battery from the first state of charge (SOC1) to the second state of charge (SOC2) is initiated by at least one of the following events:
a predetermined operating period of the battery is reached;
a predetermined energy throughput of the battery is reached;
a battery discharge to below a predetermined threshold value of the state of charge occurs;
the battery has been disconnected; or
evidence is acquired of a discrepancy between previously acquired values of the state of charge and the battery capacity.

10. The method as claimed in claim 1, wherein the charging of the battery from the first state of charge (SOC1) to the second state of charge (SOC2) is postponed if at least one of the present conditions applies:
battery temperature drops below a predetermined threshold value; or
a predetermined operating state of the vehicle occurs, in particular deactivation of the stop/start function or cleaning of the diesel particle filter.
